(19) United States
(12) Patent Application Publication
(10) Pub. No.: US 2023/0325138 A1
(43) Pub. Date: Oct. 12, 2023

(54) IMAGE STORAGE APPARATUS, IMAGE STORAGE METHOD, AND NON-TRANSITORY COMPUTER-READABLE MEDIUM

(71) Applicant: NEC Corporation, Minato-ku, Tokyo (JP)

(72) Inventors: Yaeko YONEZAWA, Tokyo (JP); Katsumi KIKUCHI, Tokyo (JP); Soma SHIRAISHI, Tokyo (JP); Yu NABETO, Tokyo (JP)

(73) Assignee: NEC Corporation, Minato-ku, Tokyo (JP)

(21) Appl. No.: 17/923,275

(22) PCT Filed: May 14, 2020
(86) PCT No.: PCT/JP2020/019257

§ 371 Date: Jan. 25, 2023

(51) Int. Cl. G06F 3/14; G06T 5/50; G06T 7/13; G06T 7/70

(52) U.S. Cl. CPC G06F 3/14; G06T 5/50; G06T 7/13; G06T 7/70; G06T 2207/20221

(57) ABSTRACT

An image capturing apparatus includes an image acquisition unit, a display processing unit, and a storage processing unit. The display processing unit displays, on a display, an image acquired by the image acquisition unit. After the storage processing unit stores a first image in an image storage unit, the display processing unit repeatedly displays a latest image (a real-time image) generated by an image capturing unit, in a second display region being adjacent to a first display region, which is a part of the display, of the display, while displaying at least an edge of the first image in the first display region. Then, the storage processing unit performs processing for storing the real-time image or an image generated thereafter, in the image storage unit as a second image, when continuity of an edge of the first image and the real-time image in the display satisfies a criterion.

### TECHNICAL FIELD

The present invention relates to an image storage apparatus, an image storage method, and a program.

### BACKGROUND ART

In a store selling a product, a position of a product in a product shelf influences a sale of the store, and is therefore important. For example, Patent Document 1 describes that a server acquires, from a retailer, information indicating location of a product in a shelf, and analyzes whether the location is a predetermined position.

Note that, Patent Document 2 describes that a plurality of divisional images are generated by properly dividing and capturing a product shelf, the divisional images are synthesized, and an image of a full view of the product shelf is generated. The image of the full view is displayed on a terminal of a customer, when a product is sold to the customer on the Internet.

### RELATED DOCUMENT

### Patent Document

Patent Document 1: Japanese Patent Application Publication No. 2002-109177

Patent Document 2: Japanese Patent Application Publication No. 2012-146214

### SUMMARY OF THE INVENTION

### Technical Problem

In recent years, an image of a shelf on which articles such as products are placed is processed, and thereby, determination of a position of the product in the shelf is performed. Herein, when a shelf is large, a need arises to capture the shelf separately a plurality of times. In this case, a person photographing the shelf needs to fully capture the shelf.

One of objects of the present invention is to facilitate fully capturing a shelf when capturing, separately a plurality of times, the shelf in which articles are placed.

### Solution to Problem

The present invention provides an image storage apparatus including:

an image acquisition unit that acquires a first image of a part of an article shelf on which articles are placed;

a display processing unit that displays, while displaying at least an edge of the first image in a first display region which is a part of a display unit, a real-time image generated repeatedly by an image capturing unit, in a second display region being adjacent to the first display region of the display unit; and

a storage processing unit that performs, when continuity of the edge of the first image and the real-time image in the display unit satisfies a criterion, predetermined processing for storing the real-time image or an image generated thereafter, in a storage unit as a second image.

The present invention provides an image storage apparatus including,

by a computer:
acquiring a first image of a part of an article shelf on which articles are placed;
displaying, while displaying at least an edge of the first image in a first display region which is a part of a display unit, a real-time image generated repeatedly by an image capturing unit, in a second display region being adjacent to the first display region of the display unit; and
performing, when continuity of the edge of the first image and the real-time image in the display unit satisfies a criterion, predetermined processing for storing the real-time image or an image generated thereafter, in a storage unit as a second image.

The present invention provides a program causing a computer to include:

an image acquisition function of acquiring a first image of a part of an article shelf on which articles are placed;

a display processing function of displaying, while displaying at least an edge of the first image in a first display region which is a part of a display unit, a real-time image generated repeatedly by an image capturing unit, in a second display region being adjacent to the first display region of the display unit; and

a storage processing function of performing, when continuity of the edge of the first image and the real-time image in the display unit satisfies a criterion, predetermined processing for storing the real-time image or an image generated thereafter, in a storage unit as a second image.

### Advantageous Effects of Invention

The present invention facilitates fully capturing a shelf when capturing, separately a plurality of times, the shelf in which articles are placed.

### BRIEF DESCRIPTION OF THE DRAWINGS

The above-described object, other objects, features, and advantageous effects will become more apparent from a preferred example embodiment described below and the following accompanying drawings.

FIG. 1 is a diagram for describing a usage environment of an image capturing apparatus according to a first example embodiment.

FIG. 2 is a diagram illustrating one example of a functional configuration of the image capturing apparatus.

FIG. 3 is a diagram illustrating a first example of a first display region and a second display region in a display.

FIG. 4 is a diagram illustrating a second example of the first display region and the second display region in the display.

FIG. 5 is a diagram illustrating a third example of the first display region and the second display region in the display.

FIG. 6 is a diagram illustrating a hardware configuration example of the image capturing apparatus.

FIG. 7 is a flowchart illustrating one example of processing performed by the image capturing apparatus.

FIG. 8 is a diagram illustrating one example of a functional configuration of an image capturing apparatus according to a second example embodiment.

FIG. 9 is a diagram illustrating one example of a functional configuration of an image capturing apparatus according to a third example embodiment.

### DESCRIPTION OF EMBODIMENTS

Hereinafter, example embodiments of the present invention are described by use of the drawings. Note that, in all of the drawings, a similar component is assigned with a similar reference sign, and description thereof will not be repeated, as appropriate.

### First Example Embodiment

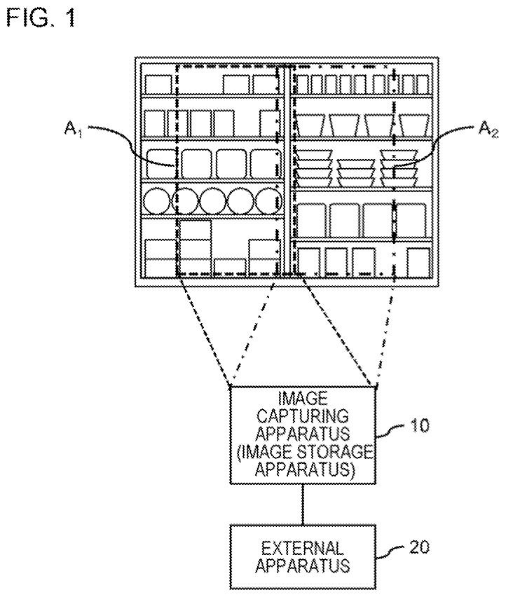

FIG. 1 is a diagram for describing a usage environment of an image capturing apparatus 10 according to the present example embodiment. The image capturing apparatus 10 is one example of an image storage apparatus, and captures an article shelf (e.g., a product shelf). An image generated by the image capturing apparatus 10 is transmitted to an external apparatus 20. The external apparatus 20 processes the image acquired from the image capturing apparatus 10, and thereby, determines a position of an article (e.g., a product) in the article shelf. A person using the external apparatus 20 confirms, by use of a processing result of the external apparatus 20, whether the position of the article in the article shelf is a desired position. For example, the external apparatus 20 determines a position of an article by performing image processing, and determines whether the determined position is at a previously determined position.

The image capturing apparatus 10 is a portable apparatus. The image capturing apparatus 10 may be a communication apparatus with an image capturing function, such as a smartphone. A user of the image capturing apparatus 10 divides an article shelf into a plurality of regions (e.g., a first shelf region A₁ and a second shelf region A₂), and generates an image for each region. In this instance, the user of the image capturing apparatus 10 generates a first image by capturing the first shelf region A₁, and then generates a second image by capturing the second shelf region A₂, in such a way that an edge of the first image and an edge of the second image are superposed on each other (i.e., become an image of the same region). In this way, the user of the image capturing apparatus 10 can fully capture the article shelf.

Herein, the image capturing apparatus 10 performs guide in such a way that the edge of the first image and the edge of the second image are superposed on each other, when generating the second image. Thus, a user of the image capturing apparatus 10 can easily superpose the edge of the first image and the edge of the second image on each other.

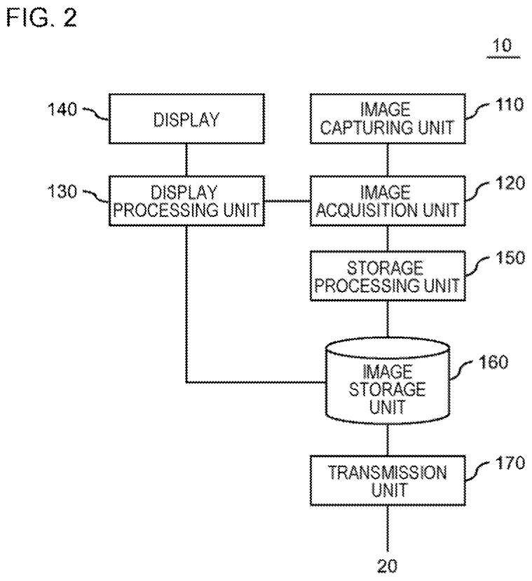

FIG. 2 is a diagram illustrating one example of a functional configuration of the image capturing apparatus 10. In the example illustrated in the present figure, the image capturing apparatus 10 includes an image capturing unit 110, an image acquisition unit 120, a display processing unit 130, a display 140 (one example of a display unit), a storage processing unit 150, and an image storage unit 160.

The image capturing unit 110 includes a capturing sensor, and repeatedly generates an image. The image acquisition unit 120 acquires an image generated by the image capturing unit 110. The storage processing unit 150 stores, in the image storage unit 160, an image satisfying a condition among images generated by the image capturing unit 110.

The display processing unit 130 displays, on the display 140, an image acquired by the image acquisition unit 120. After the storage processing unit 150 stores the first image described above in the image storage unit 160, the display processing unit 130 repeatedly displays, while displaying at least an edge of the first image in a first display region being a part of the display 140, a latest image (hereinafter, referred to as a real-time image) generated by the image capturing unit 110, in a second display region being adjacent to the first display region of the display 140. Then, the storage processing unit 150 performs, when continuity of the edge of the first image and the real-time image in the display 140 satisfies a criterion, processing (hereinafter, referred to as predetermined processing) for storing the real-time image or an image generated thereafter, in the image storage unit 160 as a second image.

A first example of predetermined processing is enabling of an image capturing button provided in the image capturing apparatus 10. For example, when the image capturing apparatus 10 is provided with a physical image capturing button, the predetermined processing is enabling of a signal generated by pressing of the image capturing button. Moreover, when the display 140 is a touch panel, the predetermined processing is displaying of an image capturing button on the touch panel. In this case, the second image stored by pressing the image capturing button may be a real-time image displayed on the display 140 when continuity satisfies a criterion, or may be a real-time image at a timing when the image capturing button is pressed.

Moreover, a second example of predetermined processing is storing a real-time image displayed on the display 140, in the image storage unit 160 as a second image, when continuity satisfies a criterion.

The image capturing apparatus 10 further includes a transmission unit 170. The transmission unit 170 transmits, to the external apparatus 20, an image stored in the image storage unit 160. A timing at which the transmission unit 170 transmits an image to the external apparatus 20 may be performed, for example, each time an image is stored in the image storage unit 160, or may be performed in a batch form.

Moreover, the image capturing apparatus 10 may not include the image storage unit 160. In this case, instead of storing an image in the image storage unit 160, the storage processing unit 150 outputs the image to the transmission unit 170. The transmission unit 170 transmits ab image acquired from the storage processing unit 150 to the external apparatus 20, and causes the external apparatus 20 to store the image. Then, the display processing unit 130 stores, as a first image, an image most recently output to the transmission unit 170 by the storage processing unit 150.

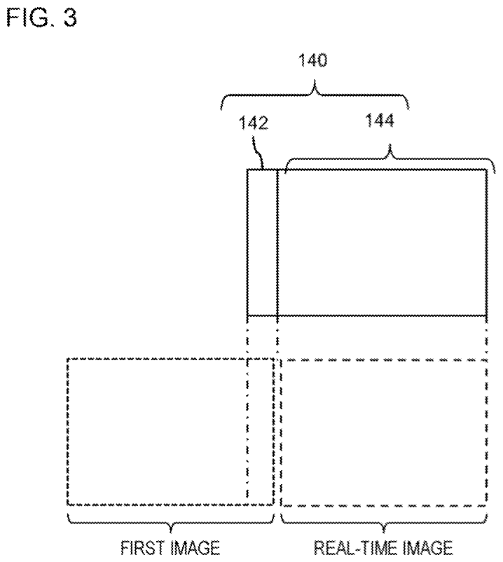

FIG. 3 is a diagram illustrating a first example of a first display region 142 and a second display region 144 in the display 140. In the present figure, the first shelf region Ai included in the first image and the second shelf region A₂ included in the second image are adjacent to each other in a lateral direction. In this case, the first display region 142 is positioned at an edge of the display 140 in a lateral direction. The second display region 144 is a remaining region of the display 140.

Then, an edge of the first image in a lateral direction is displayed in the first display region 142, and a whole of a real-time image is displayed in the second display region 144. The storage processing unit 150 performs the predetermined processing described above, when determining that an edge on a second display region 144 side of an image displayed in the first display region 142 and an end on a first display region 142 side of an image displayed in the second display region 144 are continuous with each other.

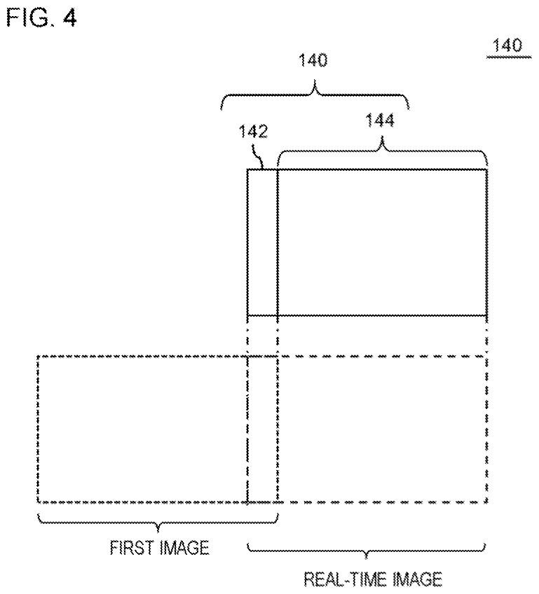

FIG. 4 is a diagram illustrating a second example of the first display region 142 and the second display region 144 in the display 140. In the present figure as well, the first shelf region Ai included in the first image and the second shelf region A₂ included in the second image are adjacent to each other in a lateral direction. An edge of the first image in a lateral direction and an edge of the real-time image are displayed in the first display region 142 in a superposed state, and a remaining region of the real-time image is displayed in the second display region 144. Herein, a user of the image capturing apparatus adjusts a capturing direction of the image capturing apparatus 10 in such a way that the edge of the first image in a lateral direction and the edge of the real-time image correspond to each other in the first display region 142. Then, the storage processing unit 150 performs the predetermined processing described above, when a difference between the edge of the first image and the edge of the real-time image in the first display region 142 becomes equal to or less than a criterion.

For example, the storage processing unit 150 compares a value of a pixel in the edge of the first image with a value of a pixel in the edge of the real-time image, and performs the predetermined processing described above when the difference becomes equal to or less than a criterion. Moreover, the storage processing unit 150 determines a kind and a position of each article included in the edge of the first image, also determines a kind and a position of each article included in the edge of the second image, and performs the predetermined processing described above when the difference of them becomes equal to or less than a criterion. In the latter case, on a required condition that kinds of articles completely correspond to each other, the storage processing unit 150 may perform the predetermined processing described above when a result (e.g., an average value or a sum value) of further statistical processing of a difference of a position of each object becomes equal to or less than a criterion.

Note that, as illustrated in the present figure, when the edge of the first image and the edge of the second image are in the same region of the article shelf, capturing of only a part of an article in an edge of an image can be suppressed, as compared with the example illustrated in FIG. 3. Thus, in any article placed on the article shelf, a possibility that an overall view is included in at least one image becomes high.

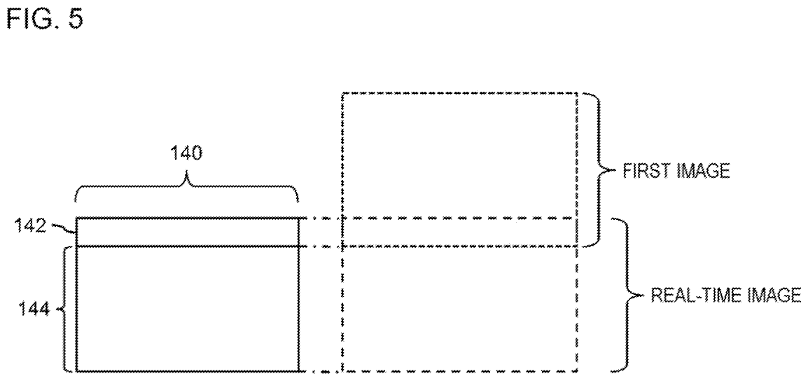

FIG. 5 is a diagram illustrating a third example of the first display region 142 and the second display region 144 in the display 140. The example illustrated in the present figure is similar to the example illustrated in FIG. 4, except that the first shelf region Ai included in the first image and the second shelf region A₂ included in the second image are adjacent to each other in a longitudinal direction. Thus, in the example illustrated in the present figure, the first display region 142 is positioned at an upper (or lower) end of the display 140. Note that, in the example illustrated in the present figure, a relation between the first image and the second image may be similar to that in FIG. 3.

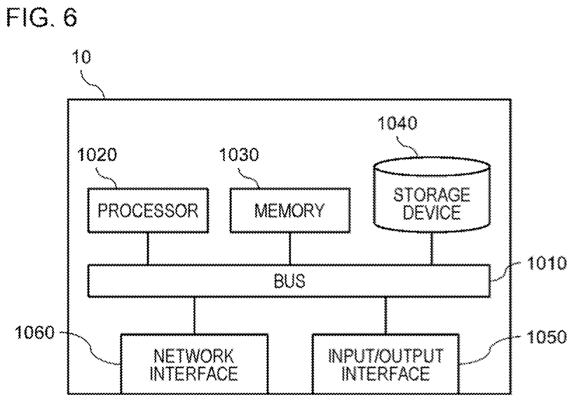

FIG. 6 is a diagram illustrating a hardware configuration example of the image capturing apparatus 10. The image capturing apparatus 10 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage achieved by a random access memory (RAM) or the like.

The storage device 1040 is an auxiliary storage achieved by a hard disk drive (HDD), a solid state drive (SSD), a memory card, a read only memory

(ROM), or the like. The storage device 1040 stores a program module that achieves each function (e.g., the image acquisition unit 120, the display processing unit 130, the storage processing unit 150, and the transmission unit 170) of the image capturing apparatus 10. The processor 1020 reads each of the program modules onto the memory 1030, executes the read program module, and thereby achieves each function being relevant to the program module. Moreover, the storage device 1040 also function as the image storage unit 160.

The input/output interface 1050 is an interface for connecting a main unit of the image capturing apparatus 10 and various kinds of pieces of input/output equipment (e.g., the display 140) with each other.

The network interface 1060 is an interface for connecting the image capturing apparatus 10 to a network. The network is, for example, a local area network (LAN) or a wide area network (WAN). A method of connecting the network interface 1060 to a network may be wireless connection, or may be wired connection. The image capturing apparatus 10 may communicate with the external apparatus 20 via the network interface 1060.

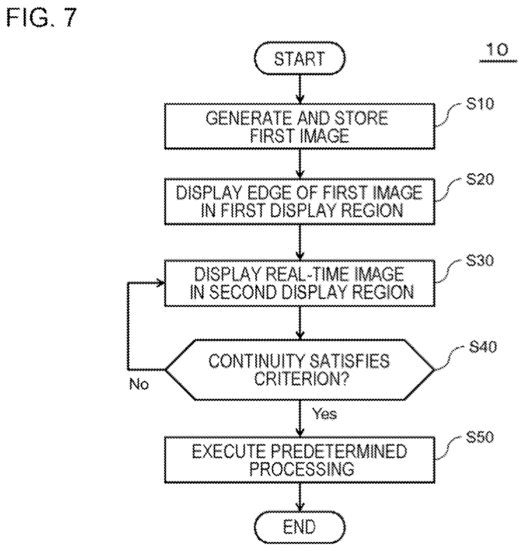

FIG. 7 is a flowchart illustrating one example of processing performed by the image capturing apparatus 10. First, the image capturing unit 110 of the image capturing apparatus 10 generates an image to be a first image. The storage processing unit 150 stores the image in the image storage unit 160 as the first image (step S 10). Subsequently, the display processing unit 130 reads the first image from the image storage unit 160, and displays an edge of the first image in the first display region 142 of the display 140 (step S20).

Then, the display processing unit 130 displays, in the second display region 144 of the display 140, a real-time image currently generated by the image capturing unit 110 (step S30). Then, when continuity of the image displayed in the first display region 142 and the image displayed in the second display region 144 satisfies a criterion (step S40: Yes), the storage processing unit 150 executes predetermined processing for storing a second image in the image storage unit 160 (step S50). Herein, examples of a determination criterion in step S40 are the example described by use of FIG. 3 and the example described by use of FIG. 4.

Thereafter, processing illustrated in FIG. 7 is again performed with the second image as a new first image.

As above, according to the present example embodiment, the display processing unit 130 of the image capturing apparatus 10 displays, while displaying at least an edge of a first image of a part of an article shelf in the first display region 142 of the display 140, a real-time image currently generated repeatedly by the image capturing unit 110 in the second display region 144 of the display 140. Then, when continuity of the first display region 142 and the second display region 144 in the display 140 satisfies a criterion, the storage processing unit 150 stores a real-time image in the image storage unit 160 as a second image. Therefore, when an article shelf is captured separately a plurality of times, the article shelf can be fully captured.

### Second Example Embodiment

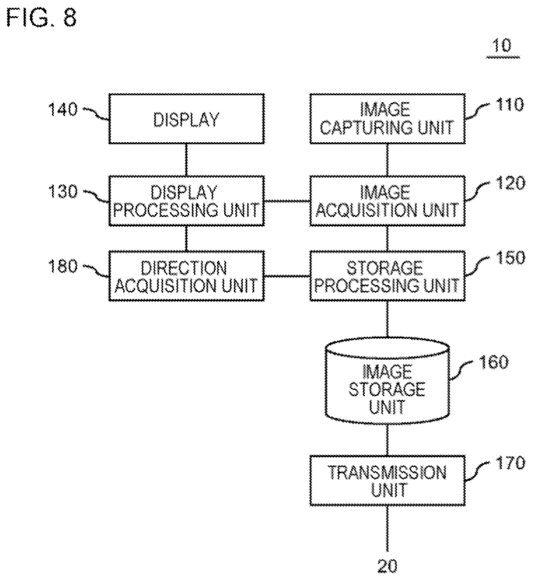

FIG. 8 is a diagram illustrating one example of a functional configuration of an image capturing apparatus 10 according to the present example embodiment. The image capturing apparatus 10 according to the present example embodiment has a similar configuration to that of the image capturing apparatus 10 according to the first example embodiment except for including a direction acquisition unit 180. The direction acquisition unit 180 acquires specification of a direction in which a first display region 142 and a second display region 144 are arranged. This specification may be input by, for example, a user via an input device of the image capturing apparatus 10, or may be transmitted to the image capturing apparatus 10 by an external apparatus 20. The followings are four examples of directions to be specified.

(1) The second display region 144 is positioned on a right side of the first display region 142.
(2) The second display region 144 is positioned on a left side of the first display region 142.
(3) The second display region 144 is positioned on an upper side of the first display region 142.
(4) The second display region 144 is positioned on a lower side of the first display region 142.

Then, a display processing unit 130 performs processing according to specification acquired by the direction acquisition unit 180.

According to the present example embodiment as well, an advantageous effect similar to that according to the first example embodiment can be acquired. Moreover, the direction acquisition unit 180 acquires specification of a direction in which the first display region 142 and the second display region 144 are arranged. The direction specified herein indicates a direction in which a first shelf region A₁ and a second shelf region A₂ of an article shelf are arranged, i.e., a direction in which an article shelf is divided when the article shelf is separately captured. Therefore, it becomes easy for a user of the image capturing apparatus 10 to capture the article shelf along a direction of the dividing.

### Third Example Embodiment

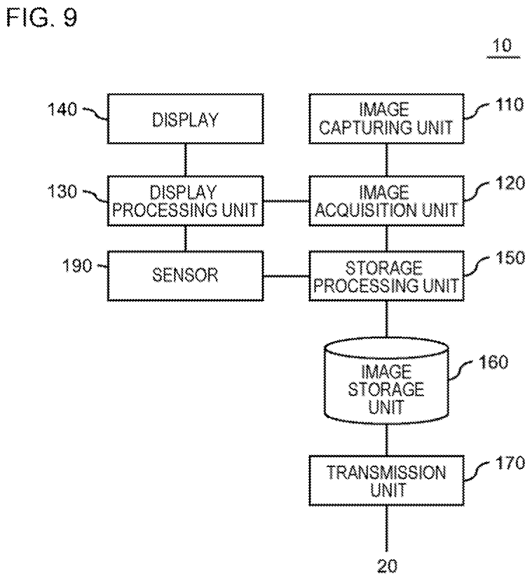

FIG. 9 is a diagram illustrating one example of a functional configuration of an image capturing apparatus 10 according to the present example embodiment. The image capturing apparatus 10 according to the present example embodiment has a similar configuration to that of the image capturing apparatus 10 according to the second example embodiment except for the following.

First, the image capturing apparatus 10 does not include a direction acquisition unit 180. Instead, the image capturing apparatus 10 includes a sensor 190. The sensor 190 is provided with at least one of, for example, an acceleration sensor and a gyro sensor, and detects at least one of a movement direction and a tilt of the image capturing apparatus 10.

Then, a display processing unit 130 determines, by use of a detection value of the sensor 190 after a first image is generated, a direction in which a first display region 142 and a second display region 144 are arranged. A specific example of an arranging direction is as described in the second example embodiment.

For example, it is supposed that the sensor 190 is provided with an acceleration sensor. In this case, when the acceleration sensor senses acceleration in a certain direction, it means that the image capturing apparatus 10 has moved in the direction, and, therefore, the display processing unit 130 locates the second display region 144 in the direction relative to the first display region 142. For example, when the acceleration sensor senses acceleration in a rightward direction, the display processing unit 130 locates the second display region 144 on a right side of the first display region 142. Moreover, when the acceleration sensor senses acceleration in a downward direction, the display processing unit 130 locates the second display region 144 under the first display region 142.

Moreover, it is supposed that the sensor 190 is provided with a gyro sensor. In this case, when the gyro sensor senses rotation in a certain direction, it means that a direction of the image capturing apparatus 10 has changed to the direction, and, therefore, the display processing unit 130 locates the second display region 144 in the direction relative to the first display region 142. For example, when the gyro sensor senses rotation in a rightward direction, the display processing unit 130 locates the second display region 144 on the right side of the first display region 142. Moreover, when the gyro sensor senses rotation in a downward direction, the display processing unit 130 locates the second display region 144 under the first display region 142.

Then, this processing is performed between step S10 and step S20 in FIG. 7.

According to the present example embodiment as well, an advantageous effect similar to that according to the second example embodiment can be acquired.

The example embodiments of the present invention have been described above with reference to the drawings, but are exemplifications of the present invention, and various configurations other than the above can also be adopted.

Moreover, although a plurality of processes (pieces of processing) are described in order in a plurality of flowcharts used in the above description, an execution order of processes executed in each example embodiment is not limited to the described order. In each example embodiment, an order of illustrated processes can be changed to an extent that causes no problem in terms of content. Moreover, each example embodiment described above can be combined to an extent that content does not contradict.

Some or all of the above-described example embodiments can also be described as, but are not limited to, the following supplementary notes.

1. An image storage apparatus including:

an image acquisition unit that acquires a first image of a part of an article shelf on which articles are placed;

a display processing unit that displays, while displaying at least an edge of the first image in a first display region of a display unit, a real-time image generated repeatedly by an image capturing unit, in a second display region being adjacent to the first display region of the display unit; and

a storage processing unit that performs, when continuity of the edge of the first image and the real-time image in the display unit satisfies a criterion, predetermined processing for storing the real-time image or an image generated thereafter, in a storage unit as a second image.

2. The image storage apparatus according to supplementary note 1, wherein

the display processing unit superposes the edge of the first image and the edge of the real-time image in the first display region, and

the storage processing unit performs the predetermined processing, when a difference between the edge of the first image and the edge of the real-time image in the first display region becomes equal to or less than a criterion.

3. The image storage apparatus according to supplementary note 2, wherein

the storage processing unit uses, as at least a part of the difference, a difference between a kind and a position of an article included in the edge of the first image, and a kind and a position of an article included in the edge of the second image.

4. The image storage apparatus according to any one of supplementary notes 1 to 3, wherein

the predetermined processing is processing of enabling an image capturing button of the image capturing unit.

5. The image storage apparatus according to any one of supplementary notes 1 to 3, wherein

the predetermined processing is processing of storing the real-time image in the storage unit.

6. The image storage apparatus according to any one of supplementary notes 1 to 5, further including

a direction acquisition unit that acquires specification of a direction in which the first display region and the second display region are arranged.

7. The image storage apparatus according to any one of supplementary notes 1 to 5, wherein

the image capturing unit is provided with a sensor for detecting at least one of a movement direction and a tilt of the image capturing unit, and generates the first image, and

the display processing unit determines, by use of a detection value of the sensor after the first image is generated, a direction in which the first display region and the second display region are arranged.

8. An image storage method including,

performing by a computer:
image acquisition processing of acquiring a first image of a part of an article shelf on which articles are placed;
display processing of displaying, while displaying at least an edge of the first image in a first display region of a display unit, a real-time image generated repeatedly by an image capturing unit, in a second display region being adjacent to the first display region of the display unit; and
storage processing of performing, when continuity of the edge of the first image and the real-time image in the display unit satisfies a criterion, predetermined processing for storing the real-time image or an image generated thereafter, in a storage unit as a second image.
   9. The image storage method according to supplementary note 8, further including,

by the computer:

in the display processing, superposing the edge of the first image and an edge of the real-time image in the first display region; and,

in the storage processing, performing the predetermined processing, when a difference between the edge of the first image and the edge of the real-time image in the first display region becomes equal to or less than a criterion.

10. The image storage method according to supplementary note 9, further including,

by the computer,

in the storage processing, using, as at least a part of the difference, a difference between a kind and a position of an article included in the edge of the first image, and a kind and a position of an article included in the edge of the second image.

11. The image storage method according to any one of supplementary notes 8 to 10, wherein

the predetermined processing is processing of enabling an image capturing button of the image capturing unit.

12. The image storage method according to any one of supplementary notes 8 to 10, wherein

the predetermined processing is processing of storing the real-time image in the storage unit.

13. The image storage method according to any one of supplementary notes 8 to 12, further including,

performing by the computer,

direction acquisition processing of acquiring specification of a direction in which the first display region and the second display region are arranged.

14. The image storage method according to any one of supplementary notes 8 to 12, wherein

the image capturing unit is provided with a sensor for detecting at least one of a movement direction and a tilt of the image capturing unit, and generates the first image,

the image storage method further including,

by the computer,

in the display processing, determining, by use of a detection value of the sensor after the first image is generated, a direction in which the first display region and the second display region are arranged.

15. A program causing a computer to include:

an image acquisition function of acquiring a first image of a part of an article shelf on which articles are placed;

a display processing function of displaying, while displaying at least an edge of the first image in a first display region of a display unit, a real-time image generated repeatedly by an image capturing unit, in a second display region being adjacent to the first display region of the display unit; and

a storage processing function of performing, when continuity of an edge of the first image and the real-time image in the display unit satisfies a criterion, predetermined processing for storing the real-time image or an image generated thereafter, in a storage unit as a second image.

16. The program according to supplementary note 15, wherein

the display processing function superposes the edge of the first image and an edge of the real-time image in the first display region, and

the storage processing function performs the predetermined processing, when a difference between the edge of the first image and the edge of the real-time image in the first display region becomes equal to or less than a criterion.

17. The program according to supplementary note 16, wherein

the storage processing function uses, as at least a part of the difference, a difference between a kind and a position of an article included in the edge of the first image, and a kind and a position of an article included in the edge of the second image.

18. The program according to any one of supplementary notes 15 to 17, wherein

the predetermined processing is processing of enabling an image capturing button of the image capturing unit.

19. The program according to any one of supplementary notes 15 to 17, wherein

the predetermined processing is processing of storing the real-time image in the storage unit.

20. The program according to any one of supplementary notes 15 to 19, further causing the computer to include

a direction acquisition function of acquiring specification of a direction in which the first display region and the second display region are arranged.

21. The program according to any one of supplementary notes 15 to 19, wherein

the image capturing unit is provided with a sensor for detecting at least one of a movement direction and a tilt of the image capturing unit, and generates the first image, and

the display processing function determines, by use of a detection value of the sensor after the first image is generated, a direction in which the first display region and the second display region are arranged.

### REFERENCE SIGNS LIST

10 Image capturing apparatus (image storage apparatus)
20 External apparatus
110 Image capturing unit
120 Image acquisition unit
130 Display processing unit
140 Display
150 Storage processing unit
160 Image storage unit
170 Transmission unit

What is claimed is:

1. An image storage apparatus comprising:
at least one memory configured to store instructions; and
at least one processor configured to execute the instructions to perform operations comprising:
acquiring a first image of a part of an article shelf on which articles are placed;
displaying, while displaying at least an edge of the first image in a first display region which is a part of display, a real-time image generated repeatedly by a camera, in a second display region being adjacent to the first display region of the display; and
performing, when continuity of the edge of the first image and the real-time image in the display unit satisfies a criterion, predetermined processing for storing the real-time image or an image generated thereafter, in a storage unit as a second image.

2. The image storage apparatus according to claim 1, wherein the operations comprise:
superposing the edge of the first image and an edge of the real-time image in the first display region; and
performing the predetermined processing, when a difference between the edge of the first image and the edge of the real-time image in the first display region becomes equal to or less than a criterion.

3. The image storage apparatus according to claim 2, wherein
the operations comprise using, as at least a part of the difference, a difference between a kind and a position of an article included in the edge of the first image, and a kind and a position of the article included in an edge of the second image.

4. The image storage apparatus according to claim 1, wherein
the predetermined processing is processing of enabling an image capturing button of the camera.

5. The image storage apparatus according to claim 1 wherein
the predetermined processing is processing of storing the real-time image in the storage.

6. The image storage apparatus according to claim 1, wherein
the operations comprise acquiring specification of a direction in which the first display region and the second display region are arranged.

7. The image storage apparatus according to claim 1, wherein
the camera is provided with a sensor for detecting at least one of a movement direction and a tilt the camera, and generates the first image, and
the operations comprise determining, by use of a detection value of the sensor after the first image is generated, a direction in which the first display region and the second display region are arranged.

8. An image storage method comprising,
by a computer:
acquiring a first image of a part of an article shelf on which articles are placed;
displaying, while displaying at least an edge of the first image in a first display region which is a part of display, a real-time image generated repeatedly by a camera, in a second display region being adjacent to the first display region of the display; and
performing, when continuity of the edge of the first image and the real-time image in the display satisfies a criterion, predetermined processing for storing the real-time image or an image generated thereafter, in a storage as a second image.

9. A non-transitory computer-readable medium storing a program causing a computer to perform operations comprising:
acquiring a first image of a part of an article shelf on which articles are placed;
displaying, while displaying at least an edge of the first image in a first display region which is a part of a display, a real-time image generated repeatedly by a camera, in a second display region being adjacent to the first display region of the display; and
performing, when continuity of the edge of the first image and the real-time image in the display unit satisfies a criterion, predetermined processing for storing the real-time image or an image generated thereafter, in a storage unit as a second image.
